(19) United States
(12) Patent Application Publication
(10) Pub. No.: US 2011/0271501 A1
(43) Pub. Date: Nov. 10, 2011

(54) MACHINING CENTER FOR A WIND TURBINE HUB

(75) Inventor: Mark F. Hopkins, Cincinnati, OH (US)

(73) Assignee: MAG IAS, LLC, STERLING HEIGHTS, MI (US)

(21) Appl. No.: 13/141,150

(22) PCT Filed: Jan. 25, 2010
(86) PCT No.: PCT/US10/21964

§ 371 Date: Jun. 21, 2011

Related U.S. Application Data
(60) Provisional application No. 61/147,955, filed on Jan. 28, 2009.

(51) Int. Cl. B23P 23/02

(52) U.S. Cl. 29/56.5

(57) ABSTRACT

A machining center is designed for machining a hub having faces that are spaced one hundred and twenty degrees from one another around the hub. The machining center includes a table for supporting the hub when it is being machined and three vertical gantries arranged around the table that are spaced one hundred and twenty degrees from one another. The gantries have X and Z axis drives for moving the gantries parallel to the faces of the hub and toward and away from the hub. At least one machining member is mounted on each of the gantries for vertical movement on the gantry and stroke drives are provided for the machining members for driving the machining members toward the center axis of the hub, allowing the three faces of the hub to be machined simultaneously by the machining center.

### BACKGROUND

A wind turbine comprises a tower that supports an array of blades that are rotated by the force of the wind. The blades are mounted on a hub and are positioned one hundred and twenty degrees from one another around the axis of rotation of the hub. Each blade is supported on the hub so that it can rotate about the longitudinal axis of the blade. The three faces of the hub that support the three blades have to be machined, and because the three faces are positioned one hundred and twenty degrees around the rotational axis of the hub, the machining presents unique fixturing challenges. Although it would be possible to machine each hub face separately, one after the other, it would be desirable to machine the three faces simultaneously, to decrease the total machining time required for each hub.

### BRIEF DESCRIPTION OF THE DRAWINGS

FIG. 1 is a perspective view of a machining center.

FIG. 2 is a plan view of the machining center of FIG. 1.

FIG. 3 is a perspective view of an alternate embodiment of a machining center.

### BRIEF DESCRIPTION OF THE DEVICE

An arrangement of machines is especially configured to machine the hub of a wind turbine. The hub has faces that are spaced one hundred and twenty degrees from one another around the rotational axis of the hub. The machining center comprises a table for supporting the hub when it is being machined and three vertical gantries that are arranged around the table and are spaced one hundred and twenty degrees from one another. The gantries have X and Z axis drives for moving the gantries parallel to the faces of the hub and toward and away from the hub. The machining members may be mounted on the gantries for vertical movement on the gantry and stroke drives are provided for the machining members for driving the machining members toward the center axis of the hub, allowing the three faces of the hub to be machined simultaneously by the machining center. Pivot mounts are provided to allow the machining members to pivot relative to the gantries in order to machine a hub face that is at an angle relative to the rotary axis of the hub.

### DETAILED DESCRIPTION OF THE PREFERRED EMBODIMENT

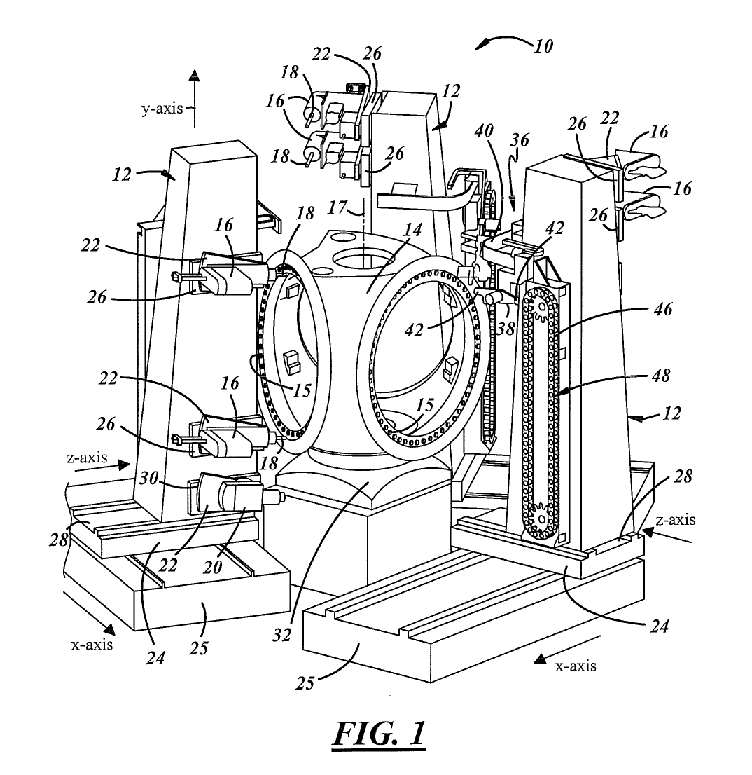

FIG. 1 is a perspective view of a machining center 10 for simultaneously machining the three faces of a wind turbine hub 14. The hub 14 as shown has a vertical axis of rotation 17 and three hub faces 15 (only two are shown) that are oriented one hundred and twenty degrees from one another around the axis of rotation 17. Three gantries 12 are oriented around the hub 14 and are provided with tooling to simultaneously drill and mill the features on each hub face 15. The hub faces 15 may be inclined relative to the axis of rotation 17 of the hub depending on the constructional features of the hub and the blade that will mount to the hub.

Each gantry 12 is equipped with two machining members such as drill units 16 that are capable of simultaneous machining operations such as drilling, back face co-boring and milling. Other machining members that are designed to perform different machining operations may be provided as required. The drill units 16 have an integral W-axis stroke drive for in-line tool feed motion in the direction of the rotary axis of the tool 18. In addition to the drill units 16, each gantry 12 may be provided with an additional machining member such as a milling spindle 20. The drill units 16 and milling spindles 20 are each mounted to the gantry 12 by Y-axis saddles 26 and 30, respectively, and are capable of vertical movement along the gantry. On top of each Y-axis saddle 26 and 30 is an A-axis mount 22 that provides an A-axis pivot so the drill units 16 and the milling spindle 20 centerline can be oriented to be perpendicular to the hub face 15 in the event that the hub face is not parallel to the axis 17 of rotation of the hub. An X-axis drive 24 may be provided to move each gantry 12 on its respective X-axis bed 25 parallel to the hub face 15. A Z-axis drive 28 may be provided to move each gantry 12 toward and away from the hub face 15. The wind turbine hub 14 is mounted on a fixed table 32 in the center of the machining center 10. The table may be provided with a B-axis drive to rotate the hub 14 relative to the gantries 12.

A tool changing mechanism 36 is mounted on the side of each gantry 12. The tool changing mechanism 36 comprises a pivoted tool changing arm 38 that is mounted on a track 40. The arm 38 has two tool gripping ends 42. A selection of tools is provided in a series of pockets 46 that are mounted on an endless chain 48. The chain 48 is driven to position a selected tool opposite one of the gripping ends 42 on the tool changing arm 38. The arm 38 then removes the selected new tool from the chain 48 and the arm travels along the track 40 until it is opposite one of the drill units 16 or the milling spindle 20. The free end of the arm removes the existing tool from the drill unit 16 or the milling spindle 20 and replaces the existing tool with the new tool in a manner well known in the art. The existing tool is then returned to an empty tool pocket 46 in the endless chain 48.

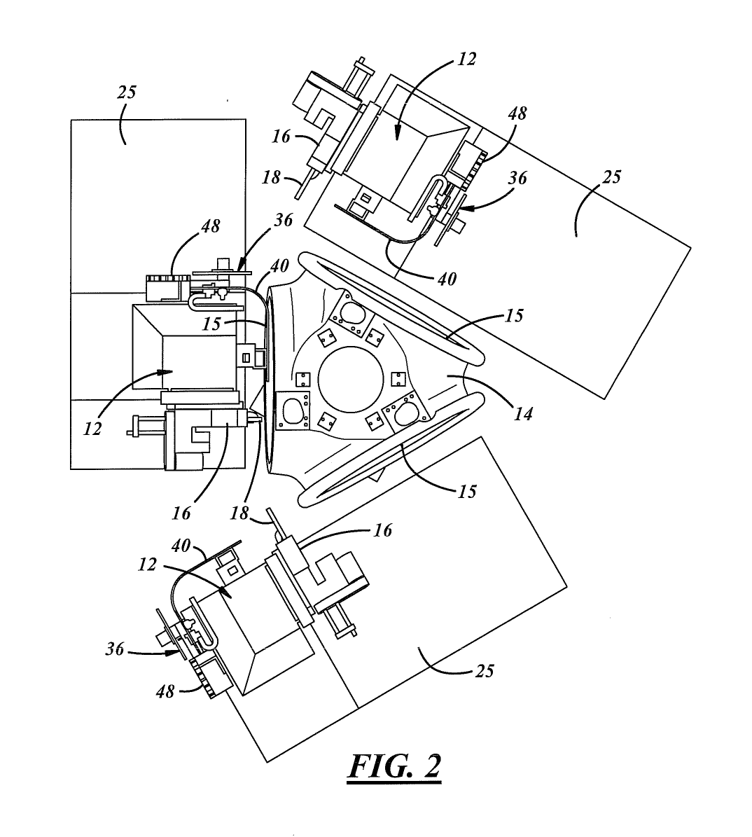

FIG. 2 is a plan view of the machining center of FIG. 1 with the all of the gantries 12 at one end of their respective X-axis bed 25 to allow part loading and unloading. As shown, the hub 14 may be unloaded from the machining center by being moved to the right of the drawing by a robot, or other commonly used part manipulating device. The hub 14 may also be removed from the machining center by an overhead crane.

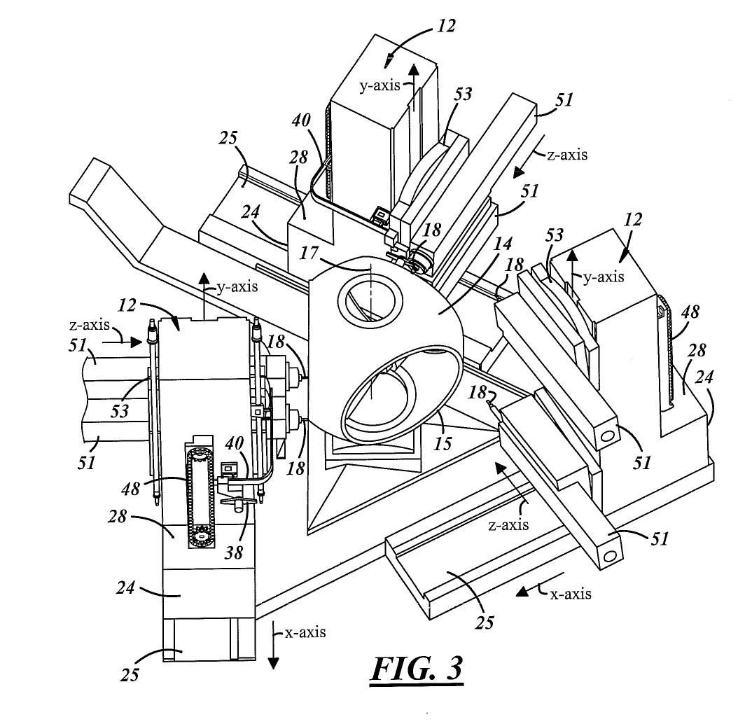

FIG. 3 is a perspective view of an alternate embodiment of the device. As in the embodiment shown in FIGS. 1 and 2, the hub 14 has a vertical axis of rotation 17 and three hub faces 15 (only one shown) that are oriented one hundred and twenty degrees from one another around the axis of rotation 17. Three gantries 12 are oriented around the hub 14 and are provided with tooling to simultaneously drill and mill the features on each hub face 15. An X-axis drive 24 may be provided to move each gantry 12 on its respective X-axis bed 25 parallel to the hub face 15. A Z-axis drive 28 may be provided move each gantry 12 perpendicular to the hub face 15. Each gantry 12 is equipped with two machining spindles 51 that are capable of simultaneous machining operations and can perform both drilling and milling operations. The hub faces 15 may be inclined relative to the axis of rotation 17 of the hub depending on the constructional features of the hub and the blade that will mount to the hub. In order to accommodate the inclined faces 15 of the hub, the machining spindles 51 are mounted on a rotary A-axis mount 53 between the spindle and the gantry 12 to allow the spindle to be oriented perpendicular to the inclined face 15 of the hub. The machining spindles have an integral w-axis stroke drive for in-line motion in the direction of the rotary axis of the tool 18. The machining spindles 51 are capable of vertical Y-axis movement along the gantry 12.

The invention has been described in an illustrative manner. It is to be understood that the terminology which has been used is intended to be in the nature of words of description rather than of limitation.

Many modifications and variations of the invention are possible in light of the above teachings. Therefore, within the scope of the appended claims, the invention may be practiced other than as specifically described.

I claim:

1. A machining center for a hub having an axis of rotation and faces to be machined that are positioned one hundred and twenty degrees from one another around the axis of rotation of the hub, the machining center comprising:
a table for supporting the hub when it is being machined so that the axis of rotation of the hub is oriented in the vertical direction;
at least a first two vertical gantries arranged around the center of the table and spaced one hundred and twenty degrees from one another;
a least one machining member mounted on each of the gantries for vertical movement on the gantry; and,
stroke drives for the machining members for driving the machining members toward the faces of the hub, whereby at least two faces of the hub may be machined simultaneously by the machining center.

2. The machining center of claim 1 further comprising:
a third vertical gantry arranged around the center of the table and spaced one hundred and twenty degrees from the first two vertical gantries; and,
a third machining member mounted on the third vertical gantry, whereby three faces of the hub may be machined simultaneously by the machining center.

3. The machining center of claim 2 further comprising:
an X-axis drive for each of the gantries, whereby each of the gantries is able to move on the X-axis parallel to one of the faces of the hub.

4. The machining center of claim 3 further comprising:
Y-axis saddles for mounting the machining members on the gantries, whereby the machining members are able to move in the vertical direction along the Y-axis and parallel to the faces of the hub.

5. The machining center of claim 2 further comprising:
an A-axis pivot for the machining members, whereby the machining members are able to pivot relative to the horizontal in order to machine a hub face that is not parallel to the axis of rotation of the hub.

6. The machining center of claim 1 further comprising:
a Z-axis drive for the gantries, whereby the gantries may be driven toward and away from the faces of the hub.

7. The machining center of claim 1 further comprising:
a B-axis drive for the table, whereby the table may be rotated relative to the gantries.

8. The machining center of claim 1 further comprising:
a tool changer mechanism mounted on at least one of the gantries, whereby the tools in the machining members on the at least one gantry can be changed for a successive number of machining operations.

9. The machining center of claim 1 further comprising:
at least two machining members mounted on at least one of the gantries for vertical movement on the gantry.

10. The machining center of claim 1 further comprising:
a plurality of machining members mounted on each of the gantries, the plurality of machining members on at least one of the gantries comprising a pair of drill units and one milling spindle.

11. The machining center of claim 1 further comprising:
a plurality of machining members mounted on each of the gantries, the plurality of machining members on at least one of the gantries comprising a pair of machining spindles.
